(19) United States
(12) Patent Application Publication
(10) Pub. No.: US 2026/0171854 A1
(43) Pub. Date: Jun. 18, 2026

(54) INDUCTIVE CHARGING DEVICE, SYSTEM FOR INDUCTIVE ENERGY TRANSFER AND METHOD FOR GENERATING A CONTROL CURRENT

(71) Applicant: MAHLE International GmbH, Stuttgart (DE)

(72) Inventors: Siyuan Lu, Stuttgart (DE); Simon Joos, Ditzingen (DE); Anja Sewalski, Schwieberdingen (DE)

(21) Appl. No.: 19/417,293

(22) Filed: Dec. 11, 2025

(30) Foreign Application Priority Data
Dec. 12, 2024 (DE) 102024137362.8

(51) Int. Cl. H02J 50/90; B60L 53/122; B60L 53/39; H02J 50/00; H02J 50/12; H02J 50/40

(52) U.S. Cl. CPC H02J 50/90; B60L 53/122; B60L 53/39; H02J 50/005; H02J 50/12; H02J 50/402

(57) ABSTRACT

An inductive charging device includes an energy coil for wireless power transfer and a positioning device with a transmit coil for alignment detection. A control device generates a drive current for the transmit coil by producing an AC carrier signal, pulse shaping the signal into an amplitude-modulated AC signal via a pulse signal, and filtering the modulated signal to attenuate harmonics.

### CROSS-REFERENCE TO RELATED APPLICATIONS

This application claims priority to German Patent Application No. DE102024137362.8, filed on Dec. 12, 2024, the contents of which is hereby incorporated by reference in its entirety.

### TECHNICAL FIELD

The disclosure relates to an inductive charging device, a system for inductive energy transfer, and a method for generating a drive current, in particular for a transmit coil of a positioning device.

### BACKGROUND

An inductive charging device for charging a vehicle is described in the SAE J 2954:2024-08-13 standard. The differential inductive positioning system (DIPS) is proposed as the standardized positioning system in this standard (Chapter 12; Annexes C and D). This has a positioning device (also referred to as a positioning transmitter) on the transmitting side, which is arranged in a stationary first inductive charging device (also referred to as a ground assembly or GA) preferably located in or on the ground. According to the standard, this transmitter-side positioning device has five transmit coils, each of which generates a positioning magnetic field as an alternating magnetic field with a different frequency. Each transmit coil is thus driven by an alternating current, each alternating current having a specific carrier frequency.

On the receiving side, a positioning device (also referred to as a positioning receiver) is provided, which is arranged in a mobile second inductive charging device (also referred to as a vehicle unit or vehicle assembly or VA) preferably located in or on the underbody of a vehicle. According to the standard, this receiver-side positioning device has two receiver coils that detect the positioning magnetic fields generated by the transmit coils, which can be distinguished based on their different frequencies. This information can then be used to determine the relative positioning of the inductive charging devices in relation to each other and thus ultimately the positioning of the vehicle relative to the floor-mounted inductive charging device.

In alternative designs of inductive charging devices, a different number of transmitting and/or receiving coils may also be used. In principle, it is sufficient, for example, if the transmitting positioning device has at least one transmitting coil and the receiving positioning device has at least one receiving coil.

Such charging devices or parts thereof are also known from DE 102022203489 A1, DE 102022120691 A1, and DE 102022107568 A1.

### SUMMARY

The present disclosure is based on the task of optimizing the control of at least one transmission coil, in particular with regard to distortion, EMC properties of the generated magnetic fields, and system stability.

According to one aspect of the present disclosure, an inductive charging device is provided, comprising:
a first energy coil for generating an alternating magnetic field for inductive energy transfer to a second energy coil of a second inductive charging device in an energy transfer mode;
a positioning device with at least one transmit coil for generating a positioning magnetic field for detecting the relative positioning of the energy coils to each other in a positioning operation; and
a control device for generating a drive current for driving the at least one transmit coil, wherein the control device is designed to generate the drive current by
receiving or generating an alternating current signal with a carrier frequency,
pulse shaping of the alternating current signal to generate an amplitude-modulated alternating current signal by multiplying it with a pulse signal, and
filtering to attenuate harmonics of the amplitude-modulated AC signal.

According to a further aspect of the present disclosure, a system is provided for inductive energy transfer with an inductive charging device according to one of the preceding claims and a further inductive charging device, in particular a mobile inductive charging device for attachment to and/or in a vehicle, wherein the further inductive charging device comprises:
a second energy coil for inductively receiving energy transmitted from the first energy coil in energy transfer mode; and
a positioning device with at least one receiving coil for detecting the positioning magnetic field and for recognizing the relative positioning of the energy coils to each other in positioning mode.

According to a further aspect of the present disclosure, a method is provided for generating a drive current for driving at least one transmit coil of a positioning device of an inductive charging device with a first energy coil for generating an alternating magnetic field for inductive energy transfer to a second energy coil of a second inductive charging device in an energy transfer mode and with a positioning device with at least one transmit coil for generating a positioning magnetic field for detecting the relative positioning of the energy coils to each other in a positioning mode, wherein the drive current is generated by
receiving or generating an alternating current signal with a carrier frequency,
pulse shaping of the alternating current signal to generate an amplitude-modulated alternating current signal by multiplying it with a pulse signal, and
filtering to attenuate harmonics of the amplitude-modulated AC signal.

Preferred embodiments of the disclosure are defined in the dependent claims. It is understood that the claimed method and the claimed system have similar and/or identical preferred embodiments as the claimed inductive charging device, in particular as defined in the dependent claims and as disclosed herein.

The disclosure is based on the idea of processing a modulated signal on the carrier signal (the alternating current signal) by pulse shaping and filtering in such a way that switching on and off does not occur via steep edges. To do this, the AC signal is multiplied by a pulse signal, e.g., a predetermined or (for example, in a microcontroller) generated raised cosine signal, in order to bring the overall signal (the drive current) into a desired pulse shape that has “smoother” transitions instead of steep edges in order to reduce or completely avoid distortion and harmonics. The pulse shaping is thus achieved by multiplying the carrier signal with the pulse signal (also referred to as the modulation signal). This multiplication corresponds to amplitude modulation. The choice of pulse signal waveform can ultimately influence the spectrum of the transmission signal emitted by the transmission coil (i.e., the positioning magnetic field). If the pulse signal were rectangular (simplest case), it would be difficult or impossible to comply with certain criteria (OBW, transmission band limits, etc.). The selection of a suitable pulse signal, e.g., a raised cosine signal as the pulse signal, makes it possible to comply with these criteria.

According to some implementations of the disclosure, a control and drive concept is thus proposed for the transmit coil(s) of the positioning device of the transmitter-side inductive charging device, which can be used, for example, for the GA transmit coils of the DIPS described in the SAE standard mentioned at the beginning in the GA. In the proposed solution, the transmit coil(s) is (are) supplied with a carrier current (e.g., sinusoidal) (the “alternating current signal”) with low distortion and a high degree of freedom from amplitude modulation. Therefore, the magnetic field generated by a transmission coil powered by it can meet strict EMC requirements and improve system stability.

In the solution according to some implementations of the disclosure, the alternating current signal in the transmitting coil represents a carrier, the transmitting coil frequency represents the carrier frequency of the transmitting coil, and the filtering filters the carrier. Amplitude modulation in the form of pulse shaping and filtering thus together generate the drive current for driving at least one transmit coil. Preferably, an individual drive current is generated for each transmit coil.

In a preferred embodiment, the control device is designed to generate a pulse width modulation signal as an alternating current signal. This represents an easy-to-process option for a carrier.

Preferably, the control device is further designed for low-pass or band-pass filtering of the amplitude-modulated alternating current signal. This allows unwanted harmonics to be eliminated or at least attenuated.

The control device may also be designed to adjust the effective value of the current and/or to modulate the amplitude by adjusting the duty cycle and phase of the alternating current signal. Compliance with standards can also be achieved by adjusting the phase and duty cycle, as this allows component tolerances to be compensated for, for example.

The control device can also be designed to shape the pulse of the amplitude-modulated alternating current signal using a pulse-shaping filter, in particular a raised cosine filter, a root raised cosine filter, a sinc filter, and a Gaussian filter. The pulse signal used to multiply the alternating current signal results in the desired smoothed transitions instead of steep edges.

In a further embodiment, the control device is designed to amplify or attenuate the filtered amplitude-modulated alternating current signal. This allows the amplitude of the alternating current signal to be adjusted to the desired strength.

Furthermore, in one embodiment, the control device is designed to amplify the filtered amplitude-modulated alternating current signal. This power amplification can be used if the current-carrying capacity of the other components of the control device is insufficient for the required current strength of the drive current for the transmit coil(s).

The control device can be implemented, for example, by a processor, controller (e.g., a microcontroller), or another common component. Alternatively, the control device can be implemented using separate components such as a signal generation unit, a filter unit, and an amplifier unit, each of which is implemented using dedicated hardware components, a processor, or a controller.

Furthermore, one design provides for the control device to have an overcurrent protection circuit and/or an overvoltage protection circuit on the output side. This serves to protect the components of the control device if, for example, an overvoltage is induced in a transmit coil during energy transfer operation.

In principle, a single transmit coil is sufficient for positioning. However, the positioning device preferably has several transmit coils, in particular four or five transmit coils, for generating a positioning magnetic field in each case as an alternating magnetic field with a different carrier frequency in each case. The control device is designed to generate a different drive current for controlling each transmit coil.

The inductive charging device according to some implementations of the disclosure is preferably a stationary inductive charging device, e.g., a GA within the meaning of the standard mentioned at the beginning, for attachment to and/or in a floor surface.

It is understood that the features mentioned above and those to be explained below may be used not only in the combination indicated in each case, but also in other combinations or on their own, without departing from the scope of the present disclosure.

### BRIEF DESCRIPTION OF THE DRAWINGS

Exemplary embodiments of the disclosure are shown in the following drawings and are explained in more detail in the following description, wherein identical reference numerals refer to identical or similar or functionally identical components. Showing:

FIG. 1 shows a highly simplified representation of a vehicle with an inductive charging device according to some implementations of the disclosure;

FIG. 2 shows a top view of an inductive charging device with a close-range positioning transmitter and a long-range positioning transmitter according to some implementations of the disclosure;

FIG. 3 shows an inductive charging device with a positioning receiver for a vehicle charging system according to some implementations of the disclosure;

FIG. 4 shows a block diagram of an embodiment of a system according to the invention for inductive energy transfer;

FIGS. 5A-5B show diagrams explaining modulation bandwidth requirements;

FIGS. 6A-6B show diagrams explaining the spectrum of a carrier signal with and without distortion;

FIG. 7 shows a diagram explaining the phase angle;

FIG. 8 shows a diagram of an FFT simulation example for three different signal forms;

FIG. 9 shows a block diagram of an embodiment of a control device according to some implementations of the disclosure;

FIG. 10 shows a diagram of an example output signal for generating the desired alternating current signal.

FIG. 11 shows a diagram of a pulse signal as the output of a pulse-shaping filter.

FIG. 12 shows a diagram of an amplitude-modulated alternating current signal;

FIG. 13 shows a block diagram of an exemplary embodiment of a signal processing stage of the control device according to some implementations of the disclosure;

FIG. 14 shows a diagram of a binary data stream to be transmitted;

FIG. 15 shows a diagram of an envelope generated by a pulse-shaping filter; and

FIG. 16 shows a diagram of an amplitude-modulated alternating current signal.

### DETAILED DESCRIPTION

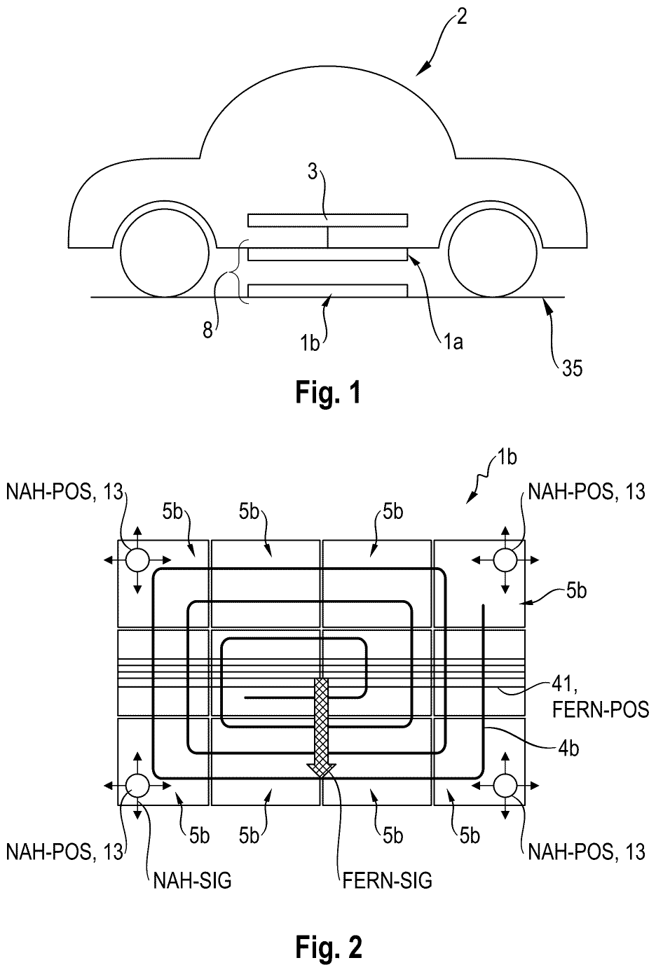

FIG. 1 shows an example of a mobile inductive charging device 1a, which is arranged on a vehicle 2 with an energy storage device 3 and is positioned above a stationary inductive charging device 1b. During operation, energy can be transferred from the stationary inductive charging device 1b to the mobile inductive charging device 1a and the vehicle's energy storage device 3 can be charged as a result.

The mobile inductive charging device 1a and the stationary inductive charging device 1b together form or are part of a vehicle charging system 8. In principle, it is also possible to operate the vehicle charging system 8 bidirectionally. In the process, energy can be temporarily transferred from the mobile inductive charging device 1a to the stationary inductive charging device 1b. The stationary inductive charging device 1b arranged on the substrate 35 in FIG. 1 can alternatively also be recessed into the roadway (not shown here). In a recessed arrangement, the inductive charging device 1b can be covered by certain layers of the road surface or be flush with the road surface. The mobile inductive charging device 1a is mounted, for example, in or on the underbody of the vehicle 2. Both inductive charging devices 1a, 1b each have an energy transfer winding (energy coil) and preferably several flux guide elements.

FIG. 2 shows a top view of an embodiment of an inductive charging device 1b. In this example, it features a positioning device (also referred to as a positioning transmitter) with a close positioning transmitter CLOSE-POS and a remote positioning transmitter REMOTE-POS. The close-range positioning transmitter NAH-POS is implemented here in the form of four close-range transmitter windings 13 (transmit coils) designed as flat coils, but can also be implemented with more or fewer transmitter windings. The remote positioning transmitter FERN-POS is implemented here as a solenoid (positioning signal winding), but can also be omitted if necessary. During a positioning process, the remote positioning transmitter FERN-POS transmits a remote positioning signal FERN-SIG in the form of an alternating magnetic field (also referred to as a remote positioning magnetic field). During a positioning process, the close positioning transmitter NAH-POS transmits several close positioning signals NAH-SIG in the form of alternating magnetic fields (also referred to as close positioning magnetic fields), which differ from each other and from the remote positioning signal FERN-SIG in terms of frequency, for example. Furthermore, an energy transfer winding 4b (energy coil), preferably designed as a flat coil, and flux guide elements 5b, for example in the form of ferrite plates, are provided.

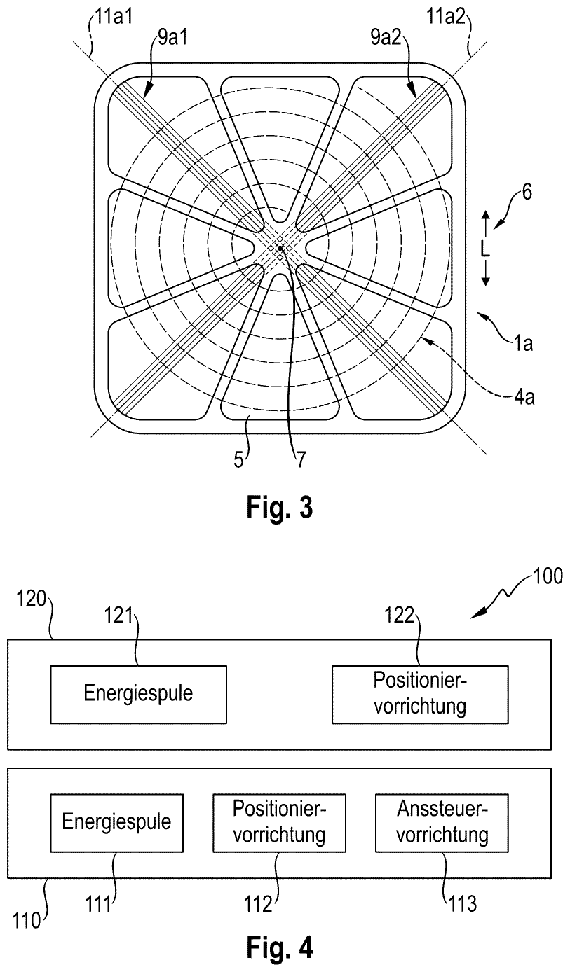

FIG. 3 shows a mobile inductive charging device 1a, which has a positioning device (also referred to as a positioning receiver device) with two sensor windings 9al and 9a2 (receiver coils), wherein in principle only one sensor winding or more sensor windings can be used. In the present exemplary embodiment, eight flow guide elements 5a are shown, which are arranged radially around the center 7 of the energy transmission winding 4a in the plane. However, there may also be more or fewer flow control elements. The energy transfer winding 4a, which is preferably designed as a flat coil and is concealed in the top view by the flux guide elements 5a, is indicated by a dashed line. The sensor windings 9a1, 9a2 are designed here as solenoids (also known as cylinder coils).

In this example, the first sensor winding 9al is arranged axially symmetrical to the second sensor winding 9a2 with respect to the longitudinal direction 6 of the vehicle. The first sensor winding 9al and the second sensor winding 9a2 intersect at least approximately in the center 7 of the energy transmission coil 4a.

The first sensor winding 9al has a first radial longitudinal direction 11al and the second sensor winding 9a2 has a second radial longitudinal direction 11a2. The angle between the first radial longitudinal direction 11a and the vehicle longitudinal direction 6 is at least approximately equal to the angle between the second radial longitudinal direction 11b and the vehicle longitudinal direction 6; however, the angles may also be different. The sensor windings 9a1, 9a2 thus form a cross-shaped arrangement.

During the charging process, the vehicle 2 is positioned above the stationary inductive charging device 1b and energy is transferred to the inductive charging device 1a. The flow control elements perform the function of flow control. When they are charged, the field lines of the magnetic field run approximately in a radial direction in them. Since the first radial longitudinal direction 11al and the second radial longitudinal direction 11a2 are also aligned radially here and thus at least approximately parallel to the magnetic field lines, relatively little to no voltage is induced in the first sensor winding 9al and in the second sensor winding 9a2. This is advantageous because the high power levels involved in energy transmission and the resulting high flux densities could otherwise easily destroy the sensor windings. Additional effort to prevent the destruction of the arrangement is therefore not necessary.

The inductive charging device 1b according to some implementations of the disclosure and the inductive charging device 1a may be part of a vehicle charging system 8 according to some implementations of disclosure. In this case, the positioning receiver can receive signals from both the close positioning transmitter NAH-POS and the remote positioning transmitter FERN-POS. This is advantageous because a positioning receiver can be used to operate two different positioning methods that function optimally at two different distance ranges. Further details on the basic structure and functionality of the inductive charging devices 1a, 1b can be found in the documents mentioned at the beginning, to which explicit reference is made here.

FIG. 4 shows a block diagram of an embodiment of a system 100 according to some implementations of the disclosure for inductive energy transfer with a first (preferably stationary) inductive charging device 110 and a second (preferably mobile) inductive charging device 120. The first inductive charging device 110 can basically be designed like the charging device 1b shown in FIG. 2. The second inductive charging device 120 can basically be designed like the charging device 1a shown in FIG. 3.

The first inductive charging device 110 comprises a first energy coil 111 for generating an alternating magnetic field for inductive energy transfer to a second energy coil 121 of the second inductive charging device 120 in an energy transfer mode. It also comprises a positioning device 112 with at least one transmit coil for generating a positioning magnetic field for detecting the relative positioning of the energy coils 111, 121 to each other in a positioning operation, and a control device 113 for generating a drive current for driving the at least one transmit coil. The second inductive charging device 120 comprises the second energy coil 121 for receiving energy transmitted inductively from the first energy coil 111 in energy transfer mode, and a positioning device 122 with at least one receiving coil for detecting the positioning magnetic field and for recognizing the relative positioning of the energy coils 111, 121 relative to each other in positioning mode. The positioning devices 112 and 122 may be designed as described in the SAE standard mentioned at the beginning or in the documents referred to therein, or they may be designed differently.

Since the positioning device 112, as used in DIPS, for example, is classified as a radio system in the 9 kHz-30 MHz frequency range, strict criteria apply. The most important of these criteria can be found in rows 1-3 of Table 1. The criterion in line 4 is another additional criterion that is closely related to criterion 3.

TABLE 1
Criteria

| No. | Criterion |
|---|---|
| 1 | Operating frequency ranges (OBW criterion) |
| 2 | Modulation bandwidth |
| 3 | Limits for interference emissions |
| 4 | Inductive phase angle between transmission current and |
| | excitation voltage, interoperability |

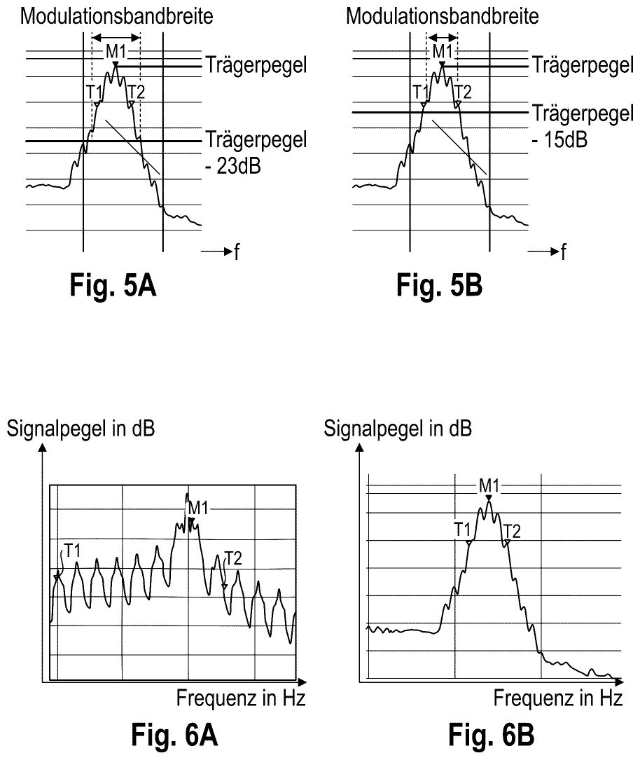

Criterion 1: This criterion states that 99% of the energy of the modulated transmission signal must lie within the transmission band limits.
Criterion 2: This criterion defines requirements for the modulation bandwidth, which are illustrated using diagrams in FIG. 5. FIG. 5A shows a diagram illustrating the definition of modulation bandwidth for carrier frequencies<135 kHz. FIG. 5B shows a diagram illustrating the definition of the modulation bandwidth for carrier frequencies>135 kHz. This places high demands on the signal shape, as the modulation bandwidth should correspond to the transmission band or ±7.5% of the carrier frequency. The stricter of the two options must be applied.
Criterion 3: This criterion specifies that there are limits for interference emissions in the 9 kHz-30 MHz and 30 MHz-1 GHz ranges that must be complied with.
Criterion 4: This criterion describes the problem caused by the change in inductance of the transmit coils due to the introduction of additional ferrite material into the system. This can be used when a GA is operated with a VA with a different ferrite arrangement. This criterion serves to ensure interoperability.

In order for the positioning device 112 to fulfill the four criteria mentioned above simultaneously, the disclosure provides a control circuit 113 designed accordingly.

Table 2 below shows how well the criteria set for the positioning device can be met for various possible control modes, in particular possible combinations of control stage and signal processing. This shows that it is only possible to reliably meet all criteria by combining a carrier signal without distortion with deliberately selected pulse shaping for amplitude modulation.

TABLE 2
Compliance with criteria

| | Criterion | Criterion | Criterion | Criterion |
|---|---|---|---|---|
| Processing | 1 | 2 | 3 | 4 |
| Carrier with distortion + | − | 0 | 0 | 0 |
| without pulse shaping | | | | |
| Carrier with distortion + | − | 0 | 0 | 0 |
| with pulse shaping | | | | |
| Carrier without | − | 0 | + | + |
| distortion + without | | | | |
| pulse shaping | | | | |
| Carrier without | + | + | + | + |
| distortion + with | | | | |
| pulse shaping | | | | |

(Legend: −: Compliance not possible, 0: Compliance possible, but costly, + Compliance possible)

Without pulse shaping, it is therefore not possible to comply with criteria 1 and 2 at suitable transmission frequencies (specified for DIPS in the SAE standard, for example), as the spectrum shown in FIG. 6A is relatively broadband and a lot of energy is also contained in the sidebands. This also has a negative impact on criterion 3. The spectrum shown in FIG. 6B shows the combination “carrier without distortion+with pulse shaping.” Here, noticeably fewer significant side bands can be seen, which are also less energetic. Therefore, it is quite possible to meet criteria 1 and 2 with this combination.

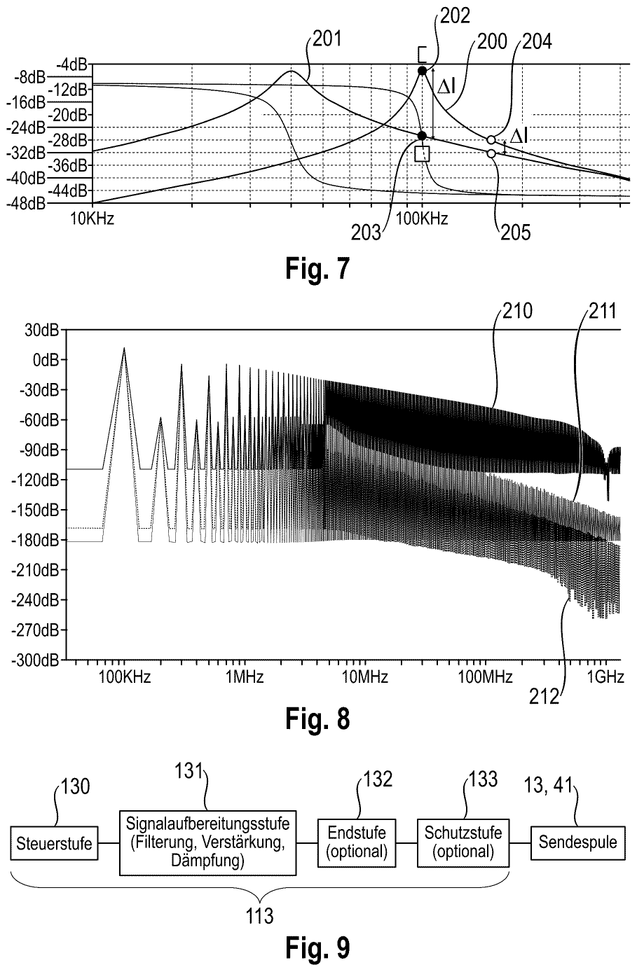

Another requirement for the transmission current is that it should have as inductive a phase angle as possible (criterion 4) in order to minimize the influence of ferrite materials, such as VA, on the amplitude of the transmission current. The reason for this is shown in the diagram in FIG. 7, which illustrates the selection of a large phase angle for the transmit coil circuit.

Curve 200 shows the level of the coil current in dB versus frequency. The reactive power compensation of the transmit coil is designed here for a resonance frequency of 100 kHz as an example. Curve 201 shows the possible case in which the inductance of the transmit coil increases due to the introduction of additional ferrite material. As a result, the resonance frequency drops to approx. 40 kHz with the same reactive power compensation design. If the system were operated at resonance with the original inductance of the transmit coil (operating point 202), the new operating point would be at 203 with the increased inductance of the transmit coil. This would result in a sharp drop in the transmission current, which is not desirable. The aim is to ensure that the influence of additional ferrite material (e.g., operation of the system with a VA from another manufacturer) remains largely unaffected in order to guarantee interoperability. This can be achieved by a large inductive phase angle between the transmit coil current and its excitation voltage. This case is illustrated in operating point 204. Here it can be seen that the effect of the change in inductance of the transmit coil due to additional ferrite material has a significantly lower impact on the coil current (operating point 205) than is the case at operating points 202 and [203].

For example, when a Class D amplifier is used, its carrier waveform becomes severely distorted at large inductive phase angles and is no longer a sine wave, but rather resembles a triangular signal. Therefore, it is difficult to meet criteria 3 and 4 if the control of the transmit coil(s) is not designed correctly.

FIG. 8 shows a diagram of an FFT simulation example for three different signal shapes for an example frequency of 100 kHz and an amplitude of 5V for a larger frequency range. This diagram illustrates the problem of potential EMC emissions from three different signal forms that differ in their edge steepness (curve 210: square wave signal; curve 211: triangular wave signal; curve 212: sine wave signal). The simulation examples are noisy, but still illustrate the relationships. The simulation results for the signals in the time domain show that the square wave signal 210 can emit significantly higher amplitudes in higher frequency ranges>1 MHz than the triangular wave signal 211 (carrier with distortion) or the sine wave signal 212 (carrier without distortion). The envelope of the triangular signal drops at 40 dB/decade from the lower cutoff frequency, whereas the envelope of the square wave signal drops at only 20 dB/decade. An ideal sine wave would only radiate at its fundamental frequency, in this case 100 kHz. Since the simulation is subject to errors and noise and the sine wave signal is therefore not ideal, a frequency spectrum can also be seen here, although it drops off most rapidly among all three signal forms toward high frequencies. This clearly shows the advantage of a signal shape that is as sinusoidal as possible from an EMC perspective compared to triangular and rectangular signal shapes.

In addition, calibrating the transmission currents in the case of a triangular signal is challenging and very time-consuming. The RMS of the fundamental wave must be set to a specific value, which can lead to significant dispersion in triangular waves with similar settings. The variance between different systems would therefore be too high. This would be a major disadvantage, especially in series production.

Since the combination of “carrier without distortion+with pulse shaping” does not directly use the PWM signal that can be generated by a microcontroller (μC), for example, but must be processed accordingly, the coil current always has a sinusoidal signal shape regardless of its phase angle (criterion 4). Signal processing can be implemented, for example, by means of a low-pass or band-pass filter stage. Therefore, criteria 3 and 4 are not mutually exclusive in this combination; rather, both can be fulfilled simultaneously.

FIG. 9 shows a block diagram of a first embodiment of a control device 113 according to some implementations of the disclosure, which can preferably be used in a stationary inductive charging device (1b in FIGS. 1 and 2; 110 in FIG. 4). The control device 113 is designed to generate a drive current for controlling the at least one transmission coil (13, 41 in FIG. 2). According to some implementations of the disclosure, the control device 113 is designed to generate the drive current by receiving or generating an alternating current signal with a carrier frequency, pulse shaping the alternating current signal to generate an amplitude-modulated alternating current signal by multiplying it with a pulse signal, and filtering to attenuate harmonics of the amplitude-modulated alternating current signal. In the embodiment shown in FIG. 9, the proposed circuit concept for the control device 113 comprises, for example, a control stage 130, a filter/amplifier stage 131, an (optional) output stage 132, and an (optional) protection stage 133. The functions of the various levels/units are as follows.

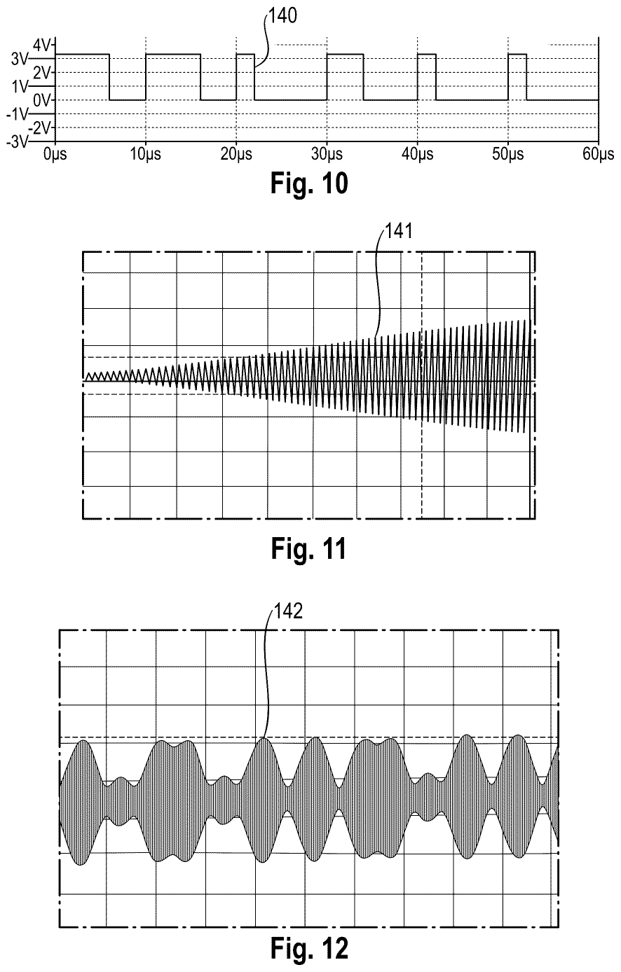

The main function of control stage 130 is to generate (or maintain) an alternating current signal with a specific frequency and to amplitude modulate the current through the transmit coil so that the effective value of the fundamental wave of the alternating current signal can be controlled. The AC signal output from control stage 130 can have any waveform. Control level 130 can usually be implemented by a microcontroller, wherein the output signal is an alternating current signal, e.g., a PWM signal. The frequency of this PWM signal corresponds to the carrier frequency of the current in the transmit coil and remains constant. The duty cycle and phase of the PWM signal can be adjusted to achieve flexible amplitude modulation of the carrier current in the transmit coil. These control variables can be used to control the current in the transmit coil. FIG. 10 shows a diagram of an example output signal 140 (voltage signal) from the control stage 130, which provides the desired current signal.

The main functions of signal processing stage 131 are to filter and amplify or attenuate the signal. Since control stage 130 generally has no current-carrying capacity and the PWM signal still contains many harmonics, this stage is designed to further process the PWM signal. The signal processing stage 131 can first remove the harmonics contained in the carrier signal, as shown in FIG. 11, which shows a diagram of an output signal 141 from the signal processing circuit 131 with a low-distortion carrier and amplitude modulation. In addition, flexible amplitude modulation is achieved by controlling the duty cycle and phase of the PWM signal in order to realize different pulse shapes and further improve the EMC performance of the signal. FIG. 12 shows a diagram of an example of raised cosine modulation achieved with the proposed circuit diagram. Thanks to flexible amplitude modulation and low-distortion carrier signal, as well as the selected modulation (e.g., raised cosine modulation, which is chosen to resemble a sine function as closely as possible), the modulated signal 142 exhibits good EMC properties and meets strict legal requirements. The signal strength can also be adjusted at this stage.

The signal processing stage 131 may comprise a filter stage and an amplifier stage. Depending on the topology, a low-pass or bandpass filter stage may be preferred as the filter stage in order to filter out high frequency components from the alternating current signal and achieve an almost sinusoidal waveform without distortion. In some cases, symmetrization of the alternating current signal may also be provided if, for example, it is necessary to convert the alternating current signal from a single-ended signal to a differential signal for further processing.

An amplifier stage generally serves to adjust the voltage level between the individual stages. This can cause both amplification and attenuation of the useful signal. Since, for example, a PWM signal generated by a μC usually has only a low signal amplitude, the function of the amplifier stage in this case is to amplify the amplitude of the alternating current signal. This allows the defined current to be achieved in the transmit coils later on in the final stage. For this purpose, the alternating current signal is amplified, in the simplest case with an amplifier circuit, preferably from an operational amplifier, preferably to a larger amplitude, wherein smaller signal amplitudes are also possible. In some cases, this function can also be performed by the filter stage.

The transmit coil of a DIPS usually requires a specific drive current. If the current drive capability of the signal conditioning stage 131 is insufficient, it can be cascaded with an output stage 132 to achieve sufficient current drive capability. The output stage 132 corresponds to the final stage of a power amplifier and ensures that the required current is supplied to the transmit coils. In general, different topologies can be used here. These can be, for example, push-pull output stages, push-pull circuits, or inverter circuits.

Due to the current transmission mode, an overvoltage can be induced in a transmission coil of the positioning device. In this case, it is advantageous to protect the drive circuit by cascading a protection stage 133, for example by means of an overvoltage protection circuit (OVP), in order to protect sensitive electronics.

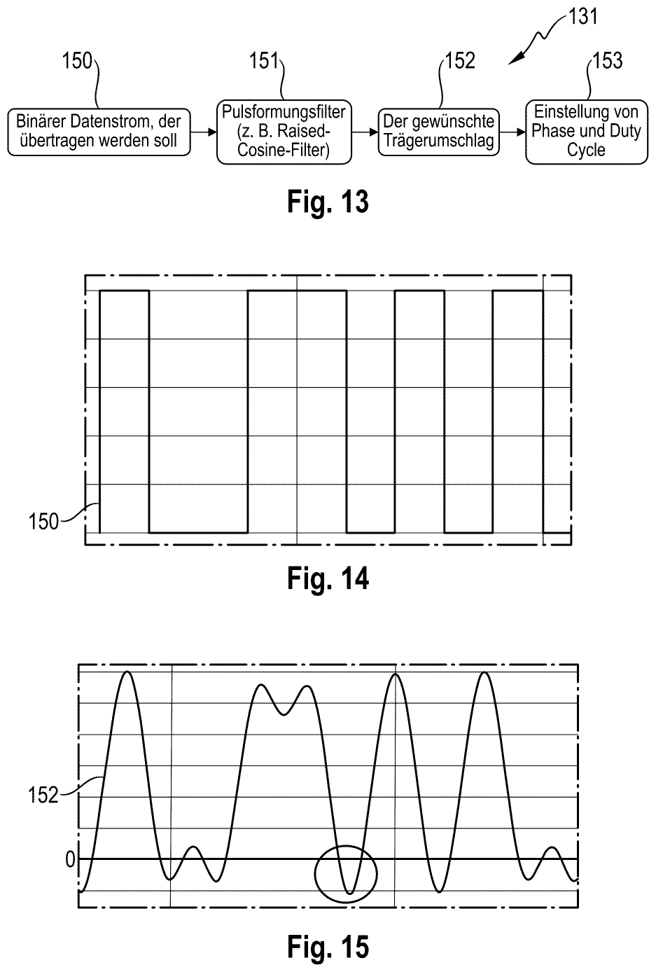

FIG. 13 shows a block diagram of an exemplary embodiment of the signal processing stage 131, in particular for explaining the functional principle of pulse shaping. A binary data stream 150 containing information that is to be modulated onto the positioning magnetic field generated by a transmit coil, for example, is shown in the diagram in FIG. 14. This information can then be transmitted to the vehicle's inductive charging device, for example to transmit information concerning the stationary inductive charging device.

The binary data stream 150 is input into a pulse-shaping filter 151 and generates the desired envelope curve 152, which is shown in the diagram in FIG. 15. Compared to the binary data stream 150 shown in FIG. 14, the envelope curve 152 is much smoother and therefore has better EMC properties. It is worth noting that the signal 152 shown in FIG. 15 can be generated, for example, using a pulse-shaping filter implemented in a microcontroller. Alternatively, the waveform can be pre-generated in a computer and stored in the microcontroller.

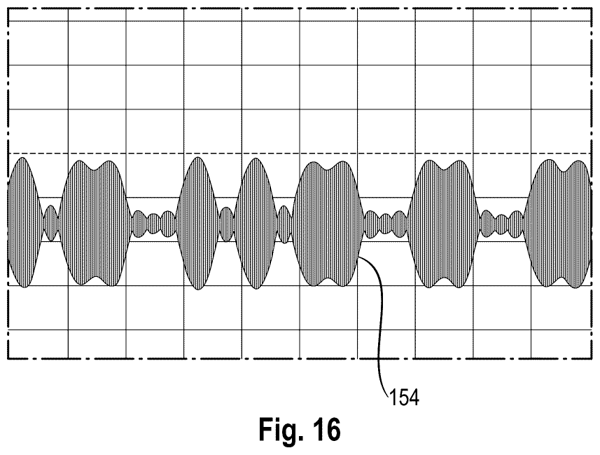

The duty cycle (Tastgrad) and phase of the PWM signal are adjusted in accordance with this signal 152 in the adjustment unit 153. When the PWM signal is set correctly, the amplitude-modulated carrier signal 154 (alternating current signal) shown in FIG. 16 is obtained, i.e., signal 152 is amplitude-modulated onto the carrier (AC signal).

The duty cycle of the PWM signal corresponds to the amplitude of the carrier signal. Depending on the downstream electrical circuit (filter, amplifier), this relationship can be described as a function: Amplitude=f (Duty Cycle). Preferably, this could be: Amplitude=k*(abs(Duty Cycle−0.5)). The greater the duty cycle, the greater the carrier amplitude. The phase adjustment of the PWM signal corresponds to the case where the envelope curve is less than zero, as indicated by the circle in FIG. 15. To make the carrier amplitude negative, the PWM signal is therefore phase-shifted by 180°.

The type of pulse-shaping filter, the parameter settings of the pulse-shaping filter, and the modulation depth can generally be adjusted flexibly.

The duty cycle and phase of the PWM signal with amplitude=f (duty cycle) can be generated in the microcontroller. Alternatively, it can be generated in advance, e.g., on a computer, and stored in the microcontroller.

In preferred embodiments, a filter stage can generate a sine wave signal with low distortion. The control circuit according to some implementations of the disclosure is also characterized by a simple structure, high accuracy, high EMC, and high stability. Thanks to these characteristics, a positioning device based on this driver circuit can be easily integrated into a GA. Pulse shaping can be achieved by controlling the AC output of the control stage. The goal is to suppress the side lobe of the modulation signal. Effective implementations of pulse shaping include the sinc filter, the raised cosine filter, and the Gaussian filter.

The control PWM signals provided by a μC usually have a rectangular waveform and a low signal amplitude of, for example, 0→3.3V. The filter stage serves to filter the high frequency components from the output signal of the control stage in order to generate an almost sinusoidal signal at the frequency of the corresponding transmit coil. This can be achieved, for example, with a low-pass or, preferably, a bandpass filter circuit. In order to achieve the necessary attenuation of harmonics, the filter can contain several stages of first or higher order, especially if a square-wave PWM signal is assumed as the output signal. The advantage of a bandpass filter stage is that low frequencies can also be effectively filtered in this case. These interference frequencies are caused, for example, by harmonics from components with low switching frequencies, such as DC-DC converters. In addition, bandpass filter circuits with the same number of stages generally allow steeper filter curves to be achieved. The filter circuit also makes it possible to generate amplification and an offset of the output signal, which has the advantage of eliminating the need for an additional amplifier stage.

In general, the PWM output signal has only a low signal amplitude. This means that it is not possible to generate high coil currents. Therefore, amplification of the transmission signal is necessary. For example, the signal can be amplified to an amplitude of 0 to 12 V; however, other amplifications are also possible. Active filter circuits, preferably with an operational amplifier, are generally used in this frequency range, as they have the advantage over passive circuits in that they do not require large and expensive components. If the transmission signal is in the kHz range, as is the case with DIPS, for example, the disadvantage of a passive filter circuit with the same order as an active filter circuit is that relatively large inductance values (in the example of an LC filter) are required. This has a negative impact on costs and installation space. The dynamic behavior of the active filter circuit can be adjusted by selecting the parameter values (RC sizing). In this case, there are high requirements for dynamic behavior so that pulse shaping can be implemented effectively.

The output stage can be implemented simply and inexpensively. Class B/AB amplifiers use two or more transistors that are biased so that each transistor is only conductive during one half-wave. The BJTs receive an input signal of the same amplitude, but with a phase shift of 180°. MOSFETs or, preferably, bipolar transistors (BJTs) can be used as transistors. Compared to Class A amplifiers, Class B amplifiers and Class AB amplifiers have the advantage that losses in the form of heat can be reduced, as the individual transistors conduct over the entire period duration. The circuit can be constructed using BJTs of the same conduction type (e.g., two NPNs) or BJTs with complementary conduction types (NPN, PNP).

The connected transmit coil may have a center tap. In this case, the inductor with center tap represents the transmit coil. The task of the center-tapped inductor is to recombine the two 180° phase-shifted output signals from the two BJTs, which provide power to the load. The load current is divided between both BJTs. The emitter terminals of both NPN BJTs shown are connected in addition to GND via a resistor. The output current gain can be adjusted via the value of these resistors. The positive half-wave is amplified by one transistor and the negative half-wave by the other. The base quiescent current can be adjusted via resistors R1 and R2. This also enables AB operation. This is advantageous because it prevents distortion at the zero crossing of the transistor input signal. The connected transmit coil may also not have a center tap. The non-deposited circuit part serves to replicate a center tap in terms of circuit technology.

A balun can be used to operate the push-pull output stage from the single-ended output signal of the filter stage. As mentioned above, the two NPN transistors must be controlled with opposite-phase input signals. The circuit should therefore be designed in such a way that it generates two signals of equal amplitude and 180° phase shift from the filter output signal. The output signals are present at the collector and emitter resistors. An alternative way of generating the control signals for the output stage transistors would be to generate the control signals using a driver transformer with a center tap.

Furthermore, the output stage can also be implemented with integrated circuits (ICs). Here, for example, a high-current operational amplifier (OPV) in a voltage follower circuit can be used as the output stage. The filter stage and the output stage can be implemented separately using different operational amplifiers. In this case, the amplification is also generated by the bandpass filter circuit.

If an OPV with high current-carrying capacity is used directly as a filter OPV, the output stage can even be omitted in this case, as it is possible to generate the corresponding coil current with it. However, the disadvantage of this solution is that, depending on the number of stages, multi-channel OPVs with high current-carrying capacity in particular are relatively expensive, which is why a solution with inexpensive amplifier OPVs is preferred for the filter circuit. In this case, only a high-current OPV is required in the output stage. The output stage in this case is represented by the high-current OPV in a voltage follower circuit.

In summary, the present disclosure thus proposes a control and drive concept for the transmit coil(s) of a positioning device of an inductive charging device, with which the transmit coil(s) is (are) supplied with a sinusoidal carrier current with low distortion and a high degree of amplitude modulation freedom. The generated transmit coil magnetic field can thus meet strict EMC requirements and improve system stability.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. All matter contained in the above description or shown in the accompanying drawings shall be interpreted as illustrative only and not limiting. Changes in detail or structure may be made without departing from the present disclosure.

What is claimed is:

1. An inductive charging device comprising:
a first energy coil configured to generate an alternating magnetic field for inductive energy transfer to a second energy coil of a second inductive charging device in an energy transfer mode;
a positioning device comprising at least one transmit coil configured to generate a positioning magnetic field for detecting a relative positioning of the first energy coil and the second energy coil to each other in a positioning mode; and
a control device configured to generate a drive current for driving the at least one transmit coil, wherein the control device is configured to generate the drive current by:
receiving or generating an alternating current signal with a carrier frequency;
pulse shaping the alternating current signal to generate an amplitude-modulated alternating current signal by multiplying the alternating current signal with a pulse signal; and
filtering the amplitude-modulated alternating current signal to attenuate harmonics.

2. The inductive charging device of claim 1, wherein the control device is configured to generate a pulse width modulation signal as the alternating current signal.

3. The inductive charging device of claim 1, wherein the control device is configured to perform low-pass filtering or band-pass filtering of the amplitude-modulated alternating current signal.

4. The inductive charging device of claim 1, wherein the control device is configured to:
set an effective value of the drive current, and
modulate an amplitude of the drive current by setting a duty cycle and a phase of the alternating current signal.

5. The inductive charging device of claim 1, wherein the control device is configured to pulse-shape the amplitude-modulated alternating current signal using a pulse-shaping filter.

6. The inductive charging device of claim 1, wherein the control device is configured to amplify or attenuate the filtered amplitude-modulated alternating current signal.

7. The inductive charging device of claim 1, wherein the control device is configured to amplify the filtered amplitude-modulated alternating current signal.

8. The inductive charging device of claim 1, wherein the control device comprises a signal generation unit, a filter unit, and an amplifier unit.

9. The inductive charging device of claim 1, wherein the control device comprises an output side having at least one of an overcurrent protection circuit or an overvoltage protection circuit.

10. The inductive charging device of claim 1, wherein the positioning device comprises a plurality of transmit coils, wherein each transmit coil of the plurality of transmit coils is configured to generate the positioning magnetic field as an alternating magnetic field with a distinct carrier frequency, and wherein the control device is configured to generate a different drive current for controlling each transmit coil of the plurality of transmit coils.

11. The inductive charging device of claim 1, wherein the inductive charging device is a stationary inductive charging device configured for attachment to or installation in a floor surface.

12. An inductive energy transfer system comprising:
the inductive charging device of claim 1; and
a second inductive charging device, wherein the second inductive charging device comprises:
a second energy coil configured to inductively receive energy transmitted from the first energy coil in the energy transfer mode; and
a positioning device comprising at least one receiving coil configured to detect the positioning magnetic field and to recognize the relative positioning of the first energy coil and the second energy coil to each other in the positioning mode.

13. A method for generating a drive current for driving at least one transmit coil of a positioning device of an inductive charging device, the inductive charging device having a first energy coil for generating an alternating magnetic field for inductive energy transfer to a second energy coil of a second inductive charging device in an energy transfer mode, and a positioning device with at least one transmit coil for generating a positioning magnetic field for detecting a relative positioning of the first energy coil and the second energy coil to each other in a positioning mode, the method comprising:
receiving or generating an alternating current signal with a carrier frequency;
pulse shaping the alternating current signal to generate an amplitude-modulated alternating current signal by multiplying the alternating current signal with a pulse signal; and
filtering the amplitude-modulated alternating current signal to attenuate harmonics.

14. The inductive charging device of claim 5, wherein the pulse-shaping filter includes a raised cosine filter.

15. The inductive charging device of claim 5, wherein the pulse-shaping filter includes a root raised cosine filter.

16. The inductive charging device of claim 5, wherein the pulse-shaping filter includes a sine filter.

17. The inductive charging device of claim 5, wherein the pulse-shaping filter includes a Gaussian filter.

18. The inductive charging device of claim 10, wherein the plurality of transmit coils includes four transmit coils.

19. The inductive charging device of claim 10, wherein the plurality of transmit coils includes five transmit coils.

20. The inductive charging device of claim 1, wherein the control device is configured to:
set an effective value of the drive current, or
modulate an amplitude of the drive current by setting a duty cycle and a phase of the alternating current signal.
